(19) United States
(12) Patent Application Publication
(10) Pub. No.: US 2017/0093029 A1
(43) Pub. Date: Mar. 30, 2017

(54) VEHICLE DATA RECORDING DEVICE

(71) Applicant: NANJING ASIATEK TECHNOLOGY LTD., Nanjing (CN)

(72) Inventors: QIU-HUANG CHEN, New Taipei (TW); ZHEN-HUI TANG, Shenzhen (CN)

(21) Appl. No.: 14/927,481

(22) Filed: Oct. 30, 2015

(30) Foreign Application Priority Data
Sep. 25, 2015 (CN) 201510619142.0

(51) Int. Cl. H01Q 1/32

(52) U.S. Cl. CPC H01Q 1/3291

(57) ABSTRACT

A vehicle data recording device includes a front panel and a first antenna. The front panel includes a first recess and a first cover detachably covering the first recess. The first antenna is mounted in the first recess and covered by the first cover.

### FIELD

The subject matter herein generally relates to a vehicle data recording device.

### BACKGROUND

In usual, a GPS data recording device includes an external antenna for searching signal, and a cable of the external antenna is long and inaesthetic.

### BRIEF DESCRIPTION OF THE DRAWINGS

Implementations of the present technology will now be described, by way of example only, with reference to the figures.

FIG. 1 is an exploded, isometric view of an embodiment of a vehicle data recording device.

FIG. 2 is an assembled, isometric view of the vehicle data recording device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “comprising,” when utilized, means “including, but not necessarily limited to”; it specifically indicates open-ended inclusion or membership in the so-described combination, group, series and the like.

The present disclosure described in relation to a vehicle data recording device.

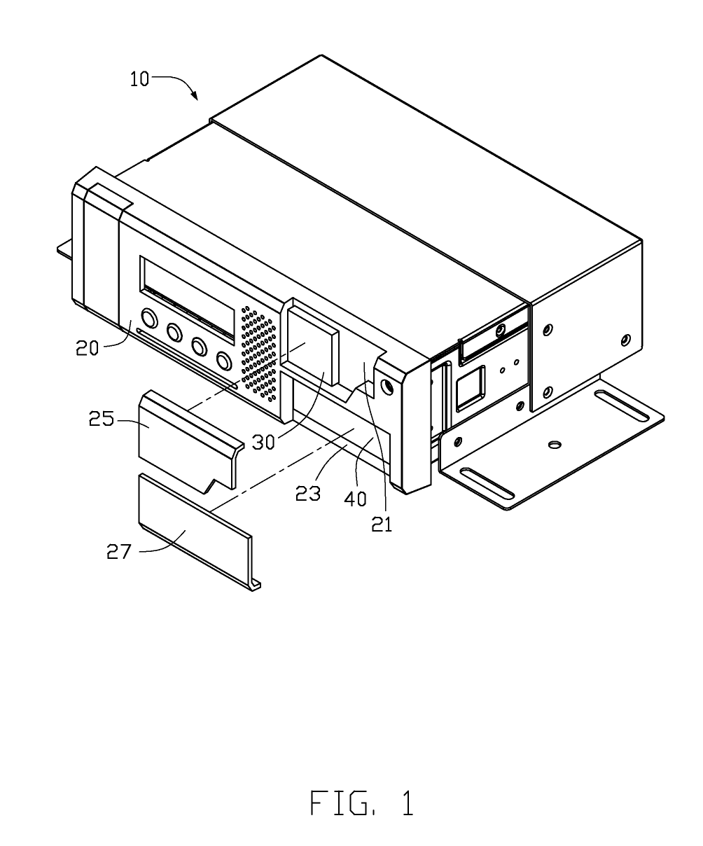

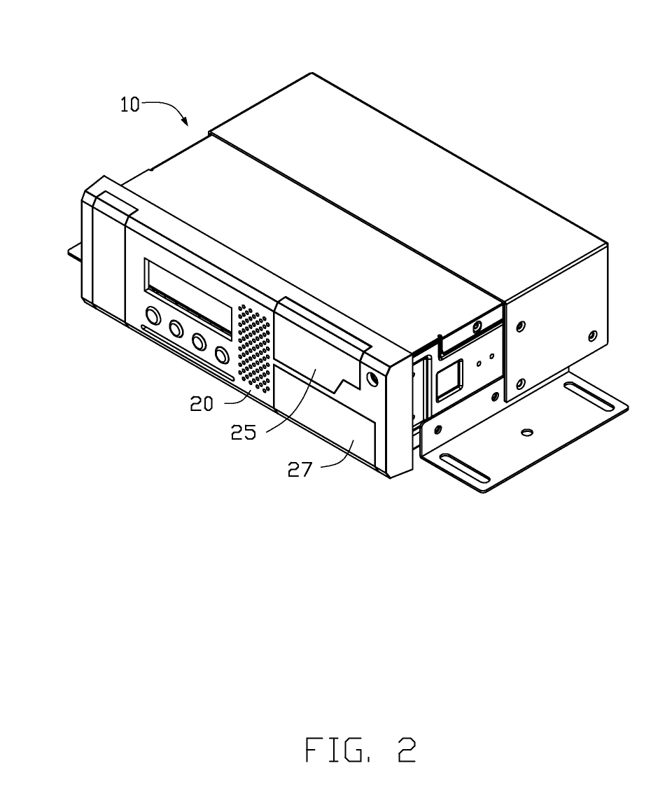

FIGS. 1 and 2 illustrate an embodiment of a vehicle data recording device 10. The vehicle data recording device 10 comprises a front panel 20, a first antenna 30, and a second antenna 40. In at least one embodiment, the first antenna 30 is a COMPASS antenna or a GPS antenna, and the second antenna 40 is a GSM antenna.

The front panel 20 comprises a first recess 21, a first cover 25 detachably covering the first recess 21, a second recess 23, and a second cover 27 detachably covering the second recess 23.

To assemble the first antenna 30 and the second antenna 40, the first cover 25 and the second cover 27 are opened. The first antenna 30 is mounted in the first recess 21 by double sided adhesive tapes, latches, or other mounting structure. The second antenna 40 is mounted in the second recess 23 by double sided adhesive tapes, latches, or other mounting structure. Cables of the first antenna 30 and the second antenna 40 respectively extend through the first recess 21 and the second recess 23 and connect to functional modules in the vehicle data recording device 10. The first cover 25 and the second cover 27 are closed to cover the first antenna 30 and the second antenna 40.

In other embodiment, the first antenna 30 and the second antenna 40 can be directly coupled to an inside surface of the front panel 20.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A vehicle data recording device, comprising:
a front panel comprising a first recess and a first cover detachably covering the first recess; and
a first antenna mounted in the first recess and covered by the first cover.

2. The vehicle data recording device of claim 1, wherein the first antenna is mounted in the first recess by a double sided adhesive tape.

3. The vehicle data recording device of claim 1, wherein the first antenna is a COMPASS antenna or a GPS antenna.

4. The vehicle data recording device of claim 1, further comprising a second antenna, wherein the front panel further comprises a second recess and a second cover detachably covering the second recess, the second antenna is mounted in the second recess and covered by the second cover.

5. The vehicle data recording device of claim 4, wherein the second antenna is mounted in the second recess by a double sided adhesive tape.

6. The vehicle data recording device of claim 4, wherein the second antenna is a GSM antenna.

7. A vehicle data recording device, comprising:
a front panel; and
a first antenna pasted to an inner side of the front panel.

8. The vehicle data recording device of claim 7, wherein the first antenna is a COMPASS antenna or a GPS antenna.

9. The vehicle data recording device of claim 7, further comprising a second antenna pasted to the inner side of the front panel.

10. The vehicle data recording device of claim 9, wherein the second antenna is a GSM antenna.
